(19) United States
(12) Patent Application Publication
(10) Pub. No.: US 2013/0045065 A1
(43) Pub. Date: Feb. 21, 2013

(54) SHEET BINDING DEVICE, POST-PROCESSING DEVICE AND IMAGE FORMING APPARATUS

(71) Applicant: Takuya ITO, Yokohama-shi (JP)

(72) Inventor: Takuya ITO, Yokohama-shi (JP)

(73) Assignee: FUJI XEROX CO., LTD., Tokyo (JP)

(21) Appl. No.: 13/352,089

(22) Filed: Jan. 17, 2012

(30) Foreign Application Priority Data
Aug. 17, 2011 (JP) 2011-178638

(51) Int. Cl. B42B 9/00

(52) U.S. Cl. 412/16

(57) ABSTRACT

A sheet binding device includes: a binding mechanism that cuts a part of a sheet stack into a predetermined shape to form a tongue portion in the sheet stack, the tongue portion having a part where one end part of the tongue portion is not separated from the sheet stack, and binds the sheet stack by bending the tongue portion to make the sheets of the sheet stack engage each other; and a folding mechanism that makes a fold in the sheet stack in conjunction with the binding operation of the binding mechanism.

### CROSS REFERENCE TO RELATED APPLICATIONS

This application is based on and claims priority under 35 USC §119 from Japanese Patent Application No. 2011-178638 filed Aug. 17, 2011.

### BACKGROUND

1. Technical Field

The present invention relates to a sheet binding device, a post-processing device and an image forming apparatus.

2. Related Art

Conventionally, there is known a technique for binding a sheet stack configured with plural sheets by forming a punched portion in the sheet stack, the punched portion being in a state where a part thereof is still attached to the sheet stack.

### SUMMARY

According to an aspect of the present invention, there is provided a sheet binding device including: a binding mechanism that cuts a part of a sheet stack into a predetermined shape to form a tongue portion in the sheet stack, the tongue portion having a part where one end part of the tongue portion is not separated from the sheet stack, and binds the sheet stack by bending the tongue portion to make the sheets of the sheet stack engage each other; and a folding mechanism that makes a fold in the sheet stack in conjunction with the binding operation of the binding mechanism.

### BRIEF DESCRIPTION OF THE DRAWINGS

An exemplary embodiment of the present invention will be described in detail based on the following figures, wherein:

FIG. 1 is a schematic configuration diagram showing a sheet binding device to which an exemplary embodiment is applied;

FIGS. 2A and 2B are schematic configuration diagrams showing a stapleless binding mechanism and peripheral members thereof;

FIG. 3 is an enlarged perspective diagram showing a portion of the stapleless binding mechanism, which applies a binding process to a sheet stack;

FIG. 4 is a schematic configuration diagram showing a structure of a periphery of an insertion hole;

FIGS. 5A to 5D are illustrative diagrams showing a section bound by the stapleless binding mechanism;

FIGS. 6A to 6D are schematic diagrams showing a sheet stack to which the binding process has been applied;

FIGS. 7A to 7D are schematic diagrams showing other examples of a sheet stack to which the binding process has been applied;

FIGS. 8A to 8D are schematic configuration diagrams showing a positional relationship between the binding section and a folding line;

FIGS. 9A and 9B are schematic configuration diagrams showing a stapleless binding mechanism and peripheral members thereof in another practice mode;

FIGS. 10A and 10B are illustrative diagrams showing a binding operation of the stapleless binding mechanism in the practice mode;

FIG. 11 is an illustrative diagram showing a sheet stack to which the binding process has been applied by still another practice mode;

FIGS. 12A to 12C are schematic configuration diagrams showing still another practice mode of a pressing member; and

FIG. 13 is a schematic diagram showing an image forming apparatus equipped with the stapleless binding mechanism.

### DETAILED DESCRIPTION

Hereinafter, an exemplary embodiment of the present invention will be described in detail with reference to the attached drawings.

### <Sheet Binding Device 100>

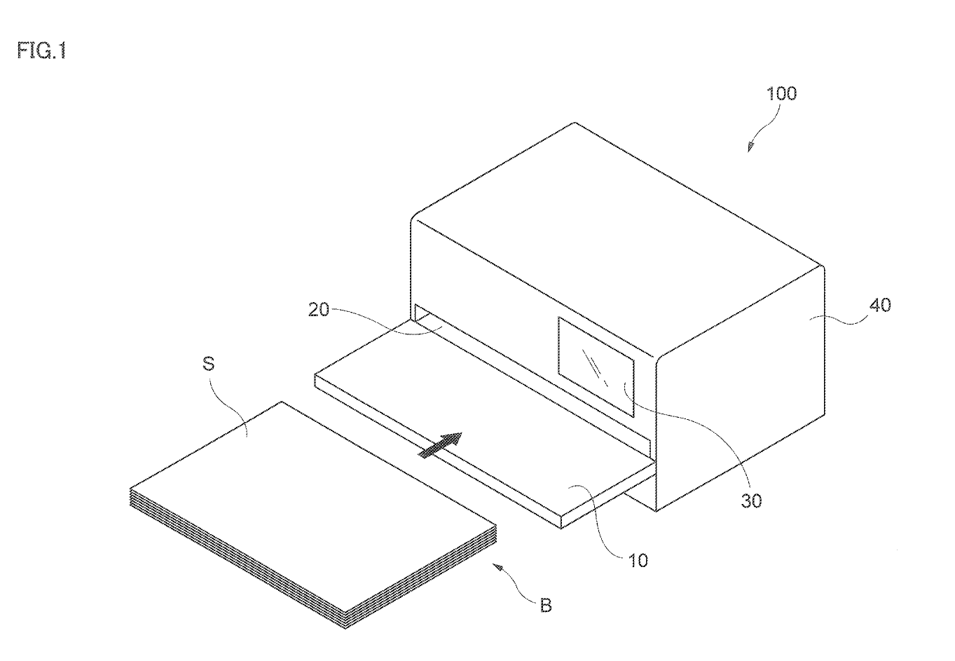

FIG. 1 is a schematic configuration diagram showing a sheet binding device 100 to which the exemplary embodiment is applied. The sheet binding device 100 shown in FIG. 1 includes: a stage 10 on which a sheet stack B formed by bundling plural sheets S is placed; an insertion hole 20 into which the sheet stack B placed on the stage 10 is inserted; and a user interface 30 that receives instructions to perform a binding process from a user. Each component of the sheet binding device 100 is contained in a housing 40.

### <Structure of Stapleless Binding Mechanism 50>

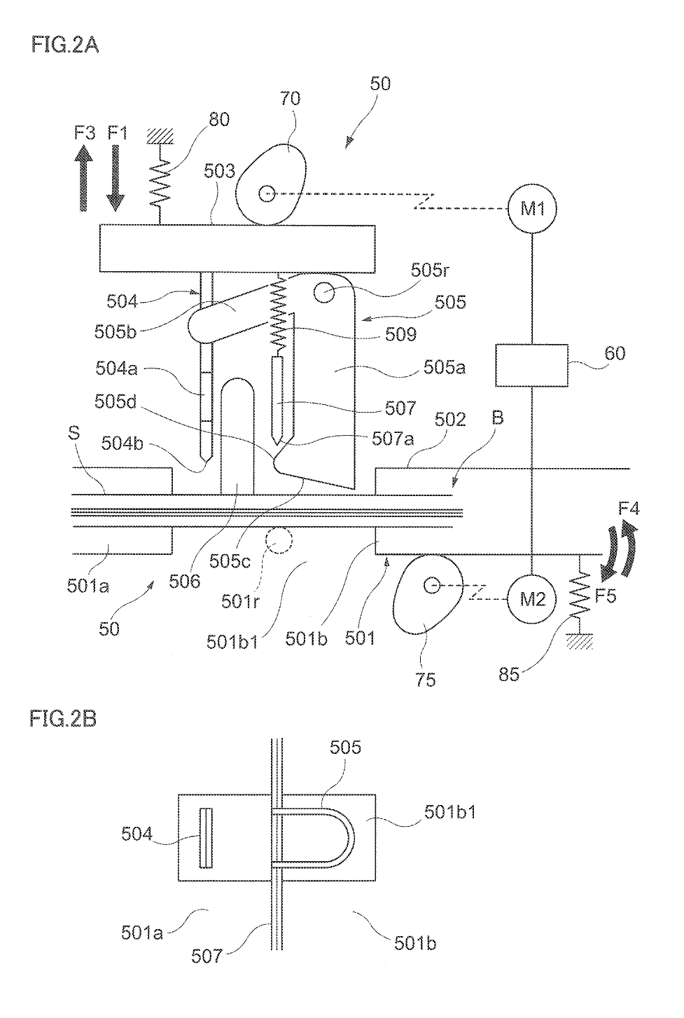

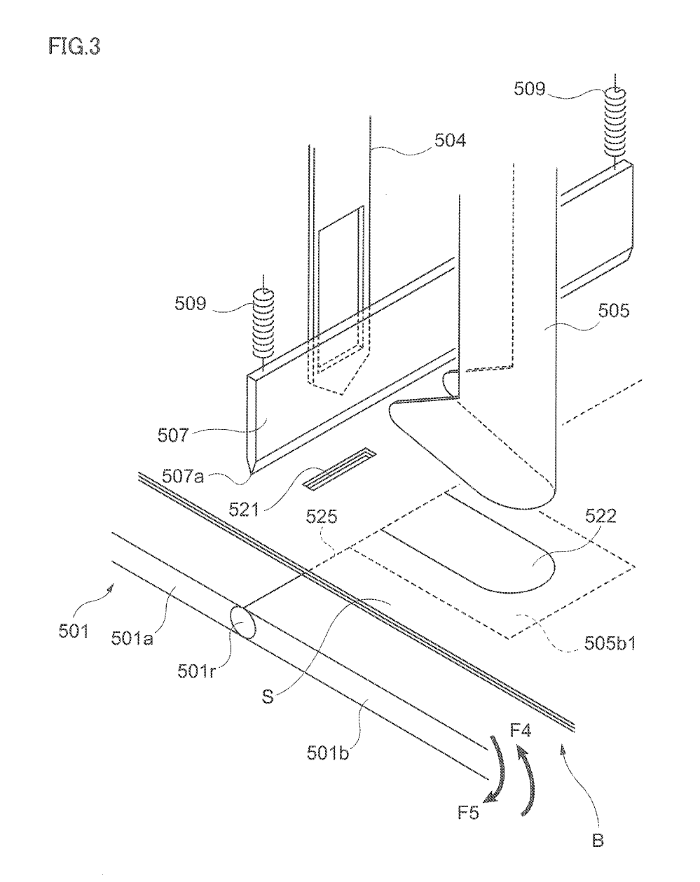

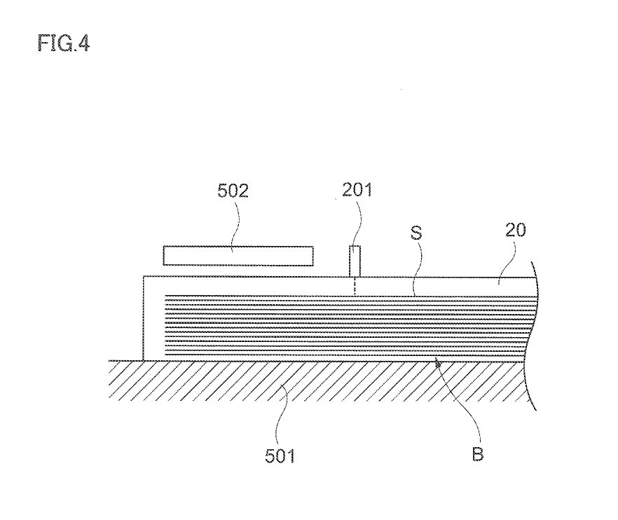

FIGS. 2A and 2B are schematic configuration diagrams showing a stapleless binding mechanism 50 and peripheral members thereof. More specifically, FIG. 2A is a front view of the stapleless binding mechanism 50 and the peripheral members thereof, and FIG. 2B is a bottom view of the stapleless binding mechanism 50 and the peripheral members thereof. FIG. 3 is an enlarged perspective diagram showing a portion of the stapleless binding mechanism 50 that applies a binding process to the sheet stack B. FIG. 4 is a schematic configuration diagram showing a structure of a periphery of the insertion hole 20.

As shown in FIG. 2A, the sheet binding device 100 (refer to FIG. 1) includes, inside of the housing 40 (refer to FIG. 1): the stapleless binding mechanism 50 that applies the binding process to an end portion of the sheet stack B inserted into the insertion hole 20 (refer to FIG. 1); a controller 60 that controls each component of the sheet binding device 100; a stapleless binding motor M1 that drives the stapleless binding mechanism 50 under the control of the controller 60; and a base stage motor M2 that moves a part of a base stage 501 (described later) under the control of the controller 60.

Further, as shown in FIG. 2A, the sheet binding device 100 (refer to FIG. 1) includes a base portion cam 70 that transmits a driving force to a base portion 503 (described later) of the stapleless binding mechanism 50 by rotating upon receiving a drive from the stapleless binding motor M1, and a base portion spring 80 that applies a force, which is opposite to the driving force transmitted by the base portion cam 70, to the base portion 503.

The sheet binding device 100 (refer to FIG. 1) also includes, as shown in FIG. 2A, a base stage cam 75 that transmits a driving force to a part of a base stage 501 (described later) rotating upon receiving a drive from the base stage motor M2, and a base stage spring 85 that applies a force, which is opposite to the driving force transmitted by the base stage cam 75, to the part of the base stage 501.

Further, the sheet binding device 100 (refer to FIG. 1) includes a moving mechanism (not shown in the figure) for moving the stapleless binding mechanism 50 according to a position where the binding process is to be performed in the sheet stack B, and a rotating mechanism (not shown in the figure) for rotating the stapleless binding mechanism 50 according to an orientation (described later) in which the binding process is performed in the sheet stack B.

Here, the stapleless binding mechanism 50 binds the end portion of the sheet stack B without using binding staples for a stapler (so-called staples) by deforming the sheets S constituting the sheet stack B. Specifically, the configuration thereof is as follows.

The stapleless binding mechanism 50 has the base stage 501 and the base portion 503 that are arranged to face each other. As shown in FIG. 2A, the base portion 503 approaches the base stage 501 (direction F1 in the figure) in the state where the sheet stack B is held by the base stage 501, and thereby the sheet stack B is bound.

As shown in FIG. 2A, the base stage 501 includes a secured base stage 501a and a movable base stage 501b that is connected to the secured base stage 501a via a rotational axis 501r provided to one end thereof.

The movable base stage 501b is provided in contact with the base stage cam 75 in the specific example shown in the figure, and is rotated around the rotational axis 501r as the rotation of the base stage cam 75 (refer to F4 and F5 in the figure). Further, in the movable base stage 501b, a cutout 501b1 is formed in a dimension such that the movable base stage 501b does not contact a punching member 505 even in rotating around the rotational axis 501r.

In the base stage 501, a base stage holding member 502 is arranged substantially in parallel to the base stage 501. As shown in FIG. 4, the base stage 501 and the base stage holding member 502 are provided with the insertion hole 20 interposed therebetween, and therefore the sheet stack B inserted into the insertion hole 20 is sandwiched by the base stage 501 and the base stage holding member 502. Moreover, as shown in FIG. 2A, the base stage 501 includes a projection portion 506 that extends toward the base portion 503 and is formed integrally with the base stage 501.

As shown in FIG. 2A, the base portion 503 includes a blade 504 that makes a cut in the sheet stack B, a punching member 505 that forms a tongue portion 522 (described later) in the sheet S constituting the sheet stack B and bends thereof, and then inserts the tongue portion 522 into the cut formed by the blade 504, and a pressing member (folding mechanism, holding member) 507 that is pressed against the sheet stack B to form a folding line 525 (described later).

The blade 504 is constituted by a substantially rectangular plate-like member that extends toward the sheet stack B sandwiched between the base stage 501 and the base stage holding member 502. Specifically, the blade 504 has an eyelet 504a in a substantially rectangular surface thereof and a tip portion 504b the width of which is reduced as approaching the sheet stack B.

The punching member 505 includes an L-shaped bending portion. One end portion of the punching member 505 is a main portion 505a, and the other end portion is a sub-portion 505b.

Further, the punching member 505 has a main portion rotational axis 505r provided in the L-shaped bending portion. The punching member 505 is rotatable around the main portion rotational axis 505r. More specifically, the main portion 505a is able to be inclined toward the blade 504. It should be noted that a gap is provided between the sub-portion 505b and the base portion 503 so that the punching member 505 is rotatable.

Here, the main portion 505a extends toward the base stage 501. Further, the main portion 505a includes a blade portion 505c on a side thereof opposite to the side where the main portion rotational axis 505r is provided, namely, on a side facing the base stage 501. The blade portion 505c is constituted by a blade that punches the shape of the tongue portion 522. It should be noted that, in the blade portion 505c, no blade is formed on a side facing the blade 504 (as shown in FIG. 2B and FIG. 3), and thereby the tongue portion 522 is not separated from the sheet S via a one end part 522a, which will be described later. Further, the main portion 505a includes a protrusion 505d, extending toward the blade 504, on a side part of the main portion 505a, specifically, on a side facing the blade 504.

As shown in FIG. 3, the pressing member 507 is a plate-like member that extends toward the sheet stack B sandwiched between the base stage 501 and the base stage holding member 502 (refer to FIG. 2A). The pressing member 507 is provided substantially in parallel to the rotational axis 501r of the base stage 501 with the sheet stack B interposed therebetween. In the specific example shown in the figure, the pressing member 507 has a tip portion 507a the width of which is reduced as approaching the sheet stack B. Though will be described in detail later, folding line 525 is formed in the sheet stack B along the tip portion 507a. Further, the pressing member 507 is connected to the base portion 503 via springs 509.

As shown in FIG. 4, the sheet binding device 100 (refer to FIG. 1) includes a sheet stack detecting sensor 201 that is arranged in a periphery of the insertion hole 20 and detects that the sheet stack B is inserted into the insertion hole 20. The sheet stack detecting sensor 201 is, in the specific example shown in the figure, provided at a position facing a top surface of the inserted sheet stack B.

### <Operation of Sheet Binding Device 100>

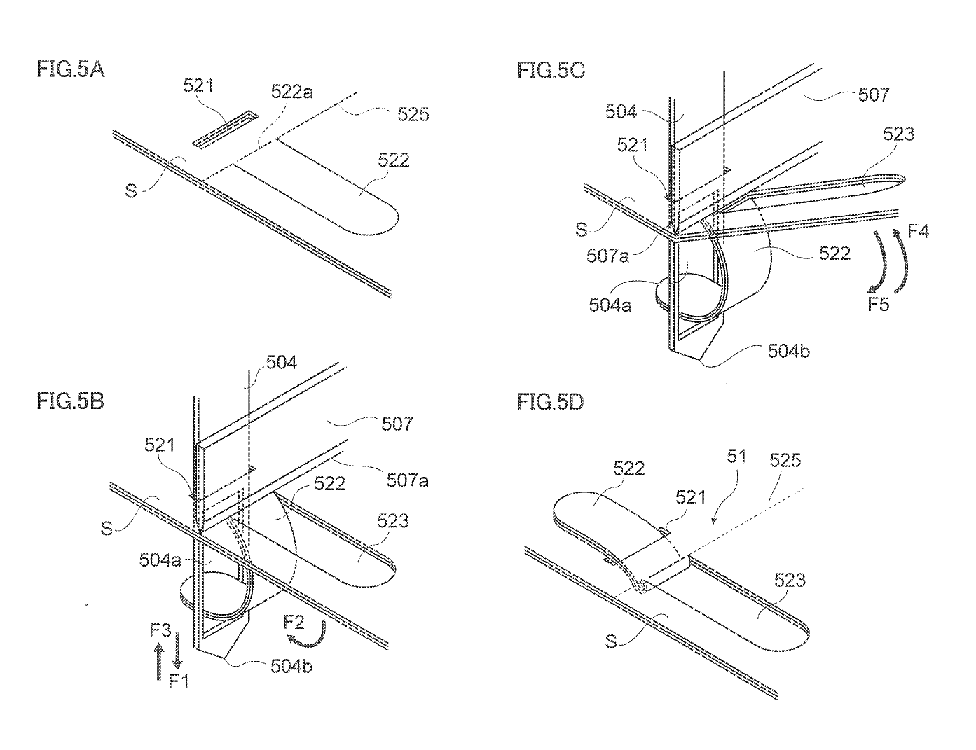

With reference to FIGS. 1 to 5A-5D, an operation of the sheet binding device 100 for performing the binding process will be described. FIGS. 5A to 5D are illustrative diagrams showing a section to be bound by the stapleless binding mechanism 50. In more detail, FIG. 5A is an illustrative diagram showing positional relationship among a slit 521, the tongue portion 522 and the folding line 525, FIG. 5B is an illustrative diagram showing a state where the slit 521 and the tongue portion 522 are formed, FIG. 5C is an illustrative diagram showing a state where the folding line 525 is formed, and FIG. 5D is an illustrative diagram showing the binding section 51 and the folding line 525 that have been formed. It should be noted that the punching member 505 is omitted in FIGS. 5B and 5C.

In the exemplary embodiment, the user interface 30 receives the instructions to perform the binding process by an operation of the user. The sheet stack detecting sensor 201 detects the sheet stack B inserted into the insertion hole 20 (refer to an arrow in FIG. 1). Then the controller 60 receives a signal regarding the instructions from the user interface 30 and a signal regarding the detection from the sheet stack detecting sensor 201, and thereby the binding process is started.

Specifically, upon receiving a signal from the controller 60 (refer to FIG. 2A), the moving mechanism (not shown in the figure) and the rotating mechanism (not shown in the figure) cause the stapleless binding mechanism 50 to move toward the position and orientation in which the binding process is performed in the sheet stack B.

At this position, as shown in FIG. 2A, the stapleless binding motor M1 drives to rotate the base portion cam 70. This makes the base portion 503 approach the base stage 501 (direction F1 in the figure), and the tip portion 504b of the blade 504 and the blade portion 505c of the punching member 505 cut through the sheet stack B. Accordingly, as shown in FIG. 5A, the slit (cut) 521 and the tongue portion 522, in which the sheet S is punched with the one end part 522a being left, are formed in each sheet S constituting the sheet stack B.

Then, as shown in FIG. 2A, as the base portion cam 70 rotates to further press down the base portion 503, the sub-portion 505b of the punching member 505 bumps against the projection portion 506 formed integrally with the base stage 501, and the punching member 505 rotates around the main portion rotational axis 505r in the clockwise direction in FIG. 2A. Consequently, the main portion 505a is inclined toward the blade 504, and the protrusion 505d of the punching member 505 approaches the blade 504. Then, as shown in FIG. 5B, the protrusion 505d of the punching member 505 bends the tongue portion 522, and pushes thereof in the direction F2 in the figure toward the eyelet 504a of the blade 504. The stapleless binding motor M1 is stopped in this state.

On the other hand, as the base portion 503 approaches the base stage 501 (direction F1 in the figure), the tip portion 507a of the pressing member 507 is pressed against the sheet stack B (refer to FIG. 5B). This makes the pressing member 507 hold the sheet stack B. Then the base stage motor M2 (refer to FIG. 2A) drives to rotate the base stage cam 75 (refer to FIG. 2A). Accordingly, the movable base stage 501b is rotated around the rotational axis 501r (refer to arrow F4 in FIG. 5C), and the sheet stack B is folded with the tip portion 507a of the pressing member 507 being a fulcrum point. The section of the sheet stack B held by the tip portion 507a of the pressing member 507 becomes the folding line 525 (refer to FIG. 5A).

Then, as the base stage cam 75 (refer to FIG. 2A) further rotates, the movable base stage 501b is rotated in an opposite direction (refer to arrow F5 in FIG. 5C) while receiving a force from the base stage spring 85, and accordingly, the sheet stack B is returned from a folded state to a flat state. It should be noted that, at this time, the pressing member 507 is in the state of holding the sheet stack B.

Next, the stapleless binding motor M1 drives again while the pressing member 507 holds the sheet stack B. As shown in FIG. 2A, after passing through the bottom dead center by further rotation of the base portion cam 70, while receiving a force from the base portion spring 80, the base portion 503 moves in the direction away from the base stage 501 (refer to F3 in FIG. 2A). As the base portion 503 rises in the direction F3 in the figure, the tongue portion 522 also rises in the state of being caught in the eyelet 504a of the blade 504. Then, as shown in FIG. 5D, the sheet stack B is bound by inserting the tongue portion 522 into the slit 521 (bending the tongue portion 522 and pushing thereof into the slit 521).

Here, in the sheet stack B, a binding hole 523 is formed at the position where the tongue portion 522 is punched, as shown in FIG. 5D. In the exemplary embodiment, the slit 521, the tongue portion 522 and the binding hole 523 are referred to as a section in which the binding process is applied (binding section) 51.

It should be noted that, by performing the binding process while the pressing member 507 holds the sheet stack B as shown in the specific example in the figure, the possibility that positions of the sheets S in the sheet stack B are misaligned due to the binding process is suppressed. Further, by folding the sheet stack B to form the folding line 525 after the tongue portion 522 is bent and pushed into the eyelet 504a of the blade 504, the possibility that the positions of the sheets S are misaligned due to the formation of the folding line 525 is suppressed.

Here, the movable base stage 501b is rotated to form the folding line 525 in the state where the tongue portion 522 is bent and pushed toward the eyelet 504a of the blade 504 and the stapleless binding motor M1 is temporarily stopped, however, the present invention is not limited thereto.

For example, the folding line 525 may be formed after the slit 521 and the tongue portion 522 are formed in the sheet stack B and before the tongue portion 522 is bent and pushed toward the eyelet 504a of the blade 504. Or, the folding line 525 may be formed by rotating the movable base stage 501b without temporarily stopping the stapleless binding motor M1. Further, the folding line 525 may be formed after the binding section 51 is formed by inserting the tongue portion 522 into the slit 521.

<Sheet Stack B to Which Binding Process has been Applied>

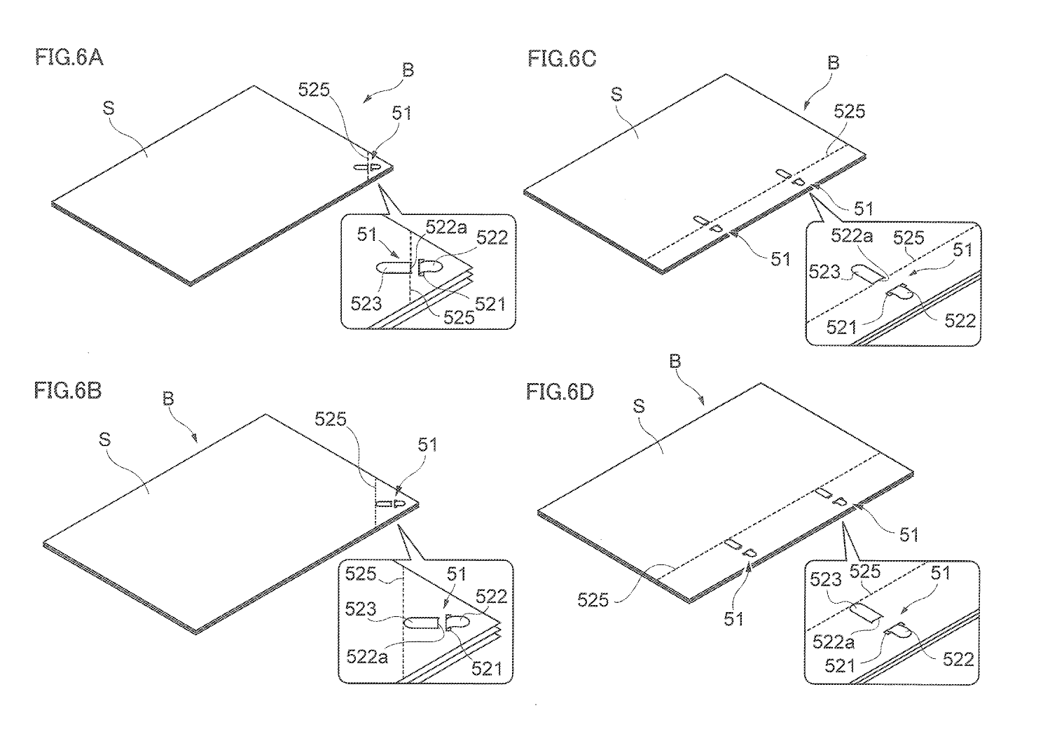

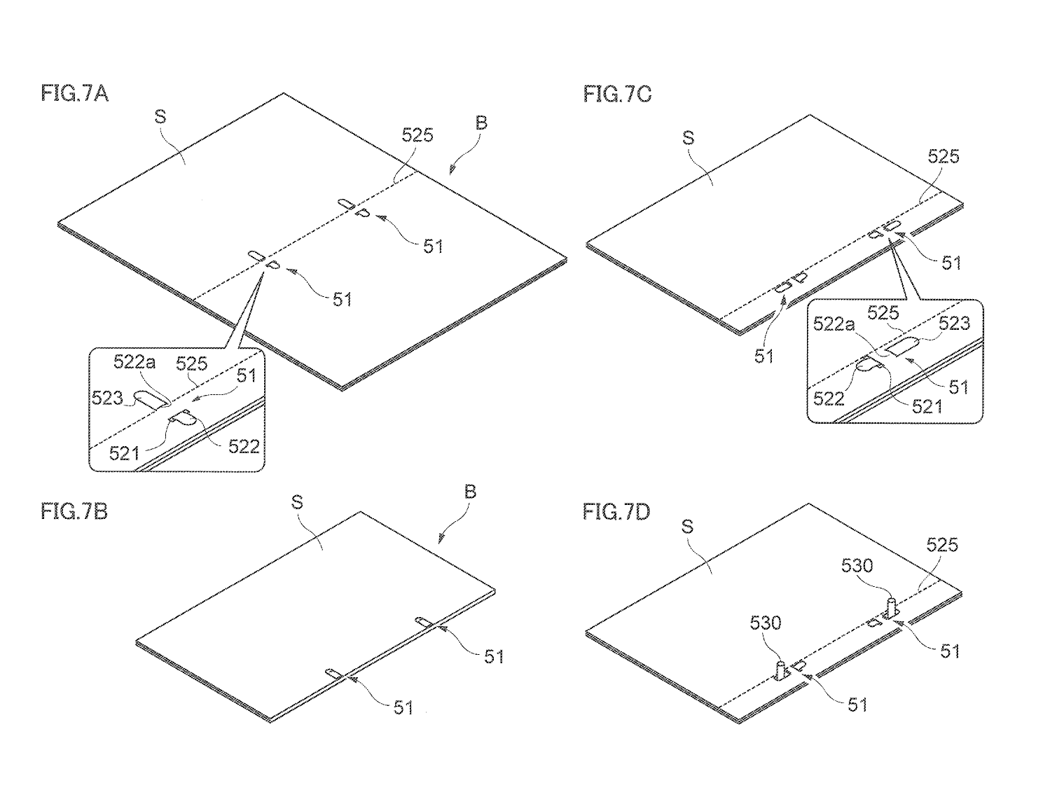

With reference to FIGS. 6A-6D and 7A-7D, the sheet stack B to which the binding process has been applied will be described. Here, FIGS. 6A to 6D are schematic diagrams each showing a sheet stack B to which the binding process has been applied. FIGS. 7A to 7D are schematic diagrams each showing another example of the sheet stack B to which the binding process has been applied.

The sheet binding device 100 (refer to FIG. 1) changes the positional relationship (angle) between the binding section 51 and the folding line 525 that are to be formed in the sheet stack B by providing the blade 504, the punching member 505 and the pressing member 507 (refer to FIGS. 2A and 2B) while changing the positional relationship of the blade 504 and the punching member 505 with the pressing member 507.

Further, the sheet binding device 100 (refer to FIG. 1) changes the position of the binding section 51 in the sheet stack B by causing the moving mechanism (not shown in the figure) to move the position of the stapleless binding mechanism 50 (refer to FIG. 2A). Moreover, by repeating the binding operation while moving the position of the stapleless binding mechanism 50 by the moving mechanism (not shown in the figure), the number of binding sections 51 formed in one sheet stack B is changed. Still further, the angle of the binding section 51 and the folding line 525 with respect to the sheet stack B is changed by rotating the orientation of the stapleless binding mechanism 50 by the rotating mechanism (not shown in the figure).

The sheet stack B in which the binding section 51 and the folding line 525 are formed is in the following modes, for example.

That is, as shown in FIG. 6A, there is a mode in which the binding process is performed by forming one binding section 51 obliquely in a corner of the sheet stack B. In the corner of the sheet stack B where the binding process has been performed, the folding line 525 is formed in the orientation intersecting the binding section 51 in the sheet stack B. The folding line 525 is formed at a position that passes through an end portion of the binding hole 523 facing the slit 521 (one end portion 522a of the tongue portion 522).

Further, as shown in FIG. 6B, there is a mode in which one binding section 51 is formed in a corner of the sheet stack B similar to FIG. 6A, and the folding line 525 is formed at a position that passes through an end portion of the binding hole 523 opposite to the end portion facing the slit 521.

Further, as shown in FIG. 6C, there is a mode in which the binding process is performed by forming two binding sections 51 along a long side of the sheet S constituting the sheet stack B. These two binding sections 51 are formed in the orientation such that the longitudinal direction of the binding sections 51 intersects the long side of the sheet S. Further, the folding line 525 is formed along the end portion of the sheet stack B in which the binding process has been performed. The folding line 525 is formed at a position that passes through end portions of the binding holes 523 facing the slits 521 (one end portions 522a of the tongue portions 522).

Moreover, as shown in FIG. 6D, there is a mode in which two binding sections 51 are formed along a long side of the sheet S constituting the sheet stack B similar to FIG. 6C, and the folding line 525 is formed at a position that passes through end portions of the binding holes 523 opposite to the end portions facing the slits 521.

Further, as shown in FIG. 7A, there is a mode in which the binding process is performed by forming two binding sections 51 along the center line of the sheet. The folding line 525 is formed along the center line of the sheet stack B to which the binding process has been applied and in the orientation intersecting each of the binding sections 51. The folding line 525 is formed at a position that passes through end portions of the binding holes 523 facing the slits 521 (one end portions 522a of the tongue portions 522).

Here, if the entire sheet stack B shown in FIG. 7A is folded along the folding line 525, the sheet stack B is brought into a state of a so-called booklet as shown in FIG. 7B. Moreover, in the specific example shown in FIG. 7B, if the sheet stack B is folded so that the tip of each tongue portion 522 inserted into the slit 521 is inside the booklet and the positions of the each tongue portion 522 and binding hole 523 are overlapped, the possibility that the binding sections bulge in the sheet stack B in the state of the booklet is suppressed.

Further, as shown in FIG. 7C, there is a mode in which the binding process is performed by forming two binding sections 51 along a long side of the sheet S constituting the sheet stack B. These two binding sections 51 are formed in the orientation such that the longitudinal direction of the binding sections 51 is along the long side of the sheet S. The folding line 525 is formed along the end portion of the sheet stack B in which the binding process has been performed. The folding line 525 is also formed along the longitudinal direction of the binding holes 523.

The portion where the folding line 525 is formed in the sheet S of the sheet stack B is in the state of being folded with ease compared to a portion of the sheet S other than the folding line 525. Accordingly, if a user turns over the sheet S of the sheet stack B to which the binding process has been applied, the sheet S turned over is folded along the folding line 525. For example, when the sheet S is gradually turned over (opened) while being picked by the user with the user's fingers, the possibility that the sheet S is turned over beyond the folding line 525 as viewed from an end portion side of the sheet S, in the proximity of which the binding section 51 is not arranged, is suppressed.

Accordingly, as shown in FIGS. 6A-6D, 7C and 7D, in the case where the binding section 51 is arranged at a position beyond the folding line 525 as viewed from an end portion side of the sheet S, in the proximity of which the binding section 51 is not arranged, in other words, in the sheet S, if the portion to be turned over and the binding section 51 are arranged with the folding line 525 interposed therebetween, a result is as follows: that is, compared to the case where no folding line 525 is formed, the possibility that the tongue portion 522 of the binding section 51 comes out of the slit 521 or that the tongue portion 522 or the periphery of the slit 521 is broken (torn) and thereby the binding section 51 is damaged, as the sheet S is turned over, is suppressed.

In addition, by forming the folding line 525 by the stapleless binding mechanism 50 (refer to FIG. 2A), it becomes unnecessary for the user to make a fold on the sheet stack B on his (her) own when the user turns over the sheet S. Consequently, the possibility that the tongue portion 522 of the binding section 51 comes out of the slit 521 or the binding section 51 is damaged by the user's act itself for making a fold is suppressed.

It should be noted that, as shown in FIGS. 6C, 6D and 7C, in the case of the mode in which two binding sections 51 are formed along the end portion of the sheet S and the binding holes 523 can be observed from the outside, binding tools 530 of a two-hole file can be passed through the binding holes 523 as shown in FIG. 7D by adjusting a space between the binding sections 51. Accordingly, the sheet stack B can be bound in a file without separately forming punched holes in the sheet stack B to which the binding process has been applied.

### <Positional Relationship Between Binding Section 51 and Folding Line 525>

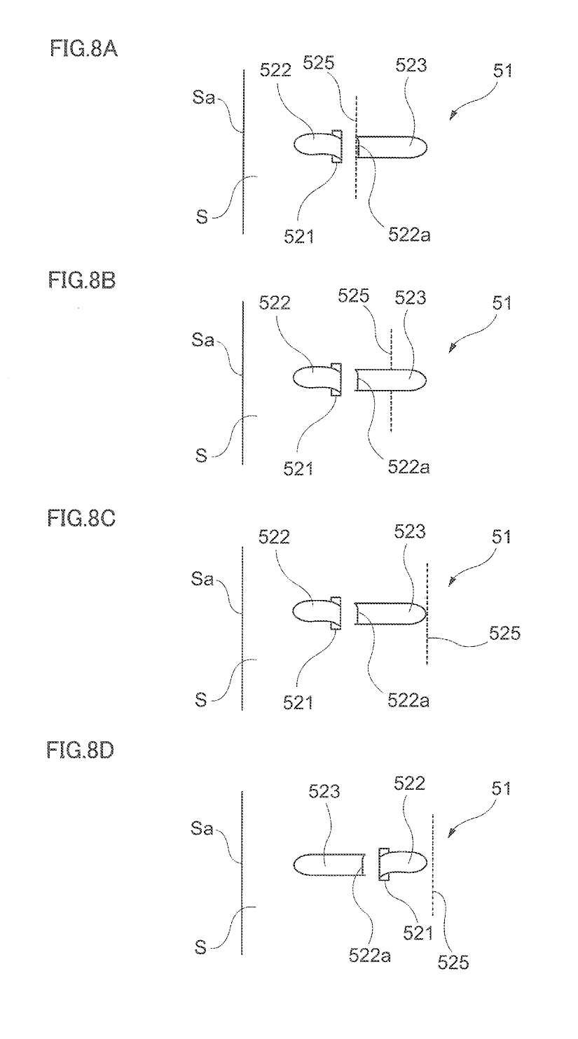

Here, with reference to FIGS. 5A-5D, 6A-6D, 7A-7D and 8A-8D, further description will be given to the positional relationship between the binding section 51 and the folding line 525. FIGS. 8A to 8D are schematic configuration diagrams showing the positional relationship between the binding section 51 and the folding line 525.

First, as shown in FIG. 5D, the tongue portion 522 of the binding section 51 is bent and inserted into the slit 521. In the section where the tongue portion 522 is arranged, the number of sheets S is larger than that in the other section because the tongue portion 522, in which the sheets S are overlaid, is additionally arranged on the sheets S originally stacked to constitute the sheet stack B (refer to FIG. 1).

In the specific example shown in the figure, the number of sheets S in the section where the tongue portion 522 is arranged is twice as large as that in the other section. In the section where the tongue portion 522 is arranged and double the number of sheets S are stacked, it is difficult to form the folding line 525 compared to the other section. Further, if the section where the tongue portion 522 is arranged is to be folded, there is a possibility that the tongue portion 522 may come out of the slit 521 due to a force applied to the tongue portion 522. Consequently, in the exemplary embodiment, the folding line 525 is formed in the section not including the tongue portion 522 as shown in FIGS. 6A-6D and 7A-7D.

The folding line 525 is formed near the binding section 51. Specifically, as shown in FIGS. 6A to 6D, in the case where the folding line 525 is in the orientation intersecting the longitudinal direction of the binding section 51, the folding line 525 is formed closer to the center portion of the sheet S than the tongue portion 522. More specifically, the folding line 525 is formed at a position that passes through the binding hole 523.

As a mode in which the folding line 525 passes through the binding hole 523, as shown in FIG. 8A, there is a mode in which the folding line 525 is formed at a position that passes through one end portion of the binding hole 523 facing the slit 521 (one end portion 522a of the tongue portion 522). Further, as shown in FIG. 8B, there is another mode in which the folding line 525 is formed at a position that passes between one end portion of the binding hole 523 facing the slit 521 (one end portion 522a of the tongue portion 522) and the other end portion of the binding hole 523 opposite to the one end portion facing the slit 521. Still further, as shown in FIG. 8C, there is a case where the folding line 525 is formed at a position that passes through one end portion of the binding hole 523 opposite to the other end portion facing the slit 521.

If the folding line 525 is formed closer to the end portion Sa of the sheet S than the position that passes through one end portion of the binding hole 523 facing the slit 521 (one end portion 522a of the tongue portion 522) (refer to FIG. 8A), a section in which the tongue portion 522 is arranged and thereby double the number of sheets S are stacked compared to the other section is to be folded. In this case, it is difficult to form the folding line 525, and there is a possibility that the tongue portion 522 may come out of the slit 521. Besides, in the first place, it becomes difficult to suppress the possibility that the tongue portion 522 or the like is torn and the binding section 51 is damaged by forming the folding line 525.

It should be noted that, if the folding line 525 is formed at a position far from the slit 521 of the binding hole 523, an area that is observable in the sheet S becomes small when one of the sheet S of the sheet stack B having been bound is turned over (opened).

Further, in the case where the folding line 525 is formed at a position that passes through the binding hole 523, the folding line 525 may be formed with a small force because the position includes a portion in which the sheet S is cut out compared to the case where the folding line 525 is formed in a portion in which no binding hole 523 is formed.

In FIGS. 6A-6D and 8A-8C, description has been given to the configuration in which, in the binding section 51, the tongue portion 522 inserted into the slit 521 is arranged closer to the end portion Sa of the sheet S, and the binding hole 523 is arranged closer to the center portion of the sheet S, however, the present invention is not limited thereto.

Here, description will be given to a configuration in which, as shown in FIG. 8D, the binding hole 523 is arranged closer to the end portion Sa of the sheet S, and the tongue portion 522 inserted into the slit 521 is arranged closer to the center portion of the sheet S. As shown in FIG. 8D, the folding line 525 is formed closer to the center portion of the sheet S than the tongue portion 522 inserted into the slit 521. By forming the folding line 525 at this position, the possibility that the tongue portion 522 comes out of the slit 521 or that the tongue portion 522 or the periphery of the slit 521 is torn and thereby the binding section 51 is damaged, as the sheet S is turned over, is suppressed.

### <Other Practice Mode 1>

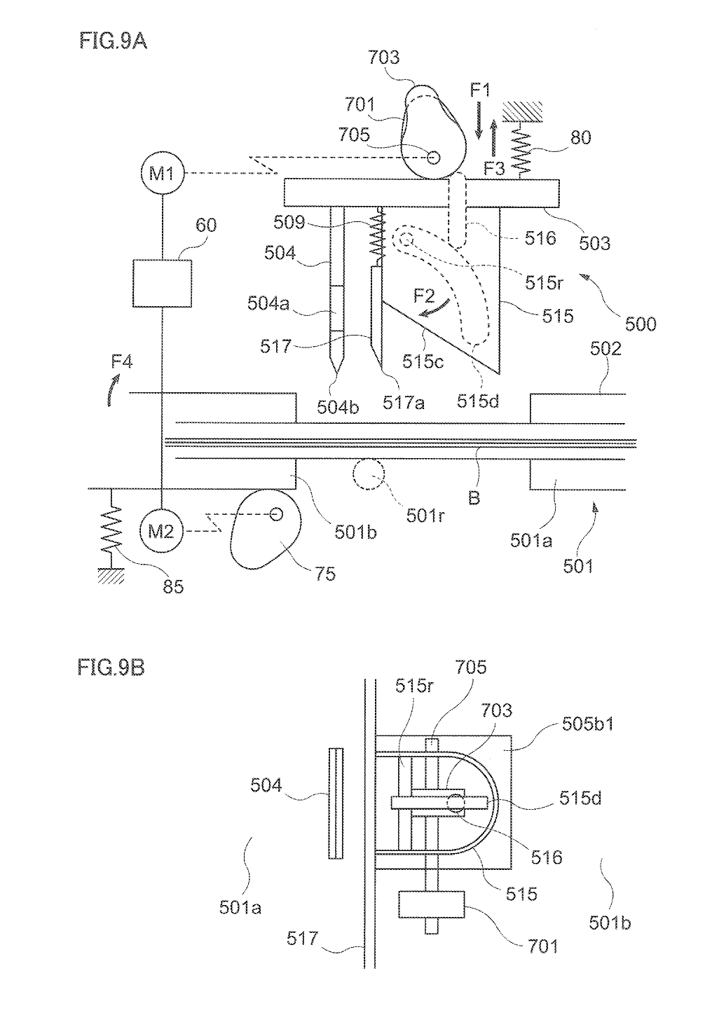

Here, with reference to FIGS. 9A and 9B, other practice modes will be described. It should be noted that FIGS. 9A and 9B are schematic configuration diagrams showing a stapleless binding mechanism and peripheral members thereof in another practice mode. More specifically, FIG. 9A is a front view of the stapleless binding mechanism 500 and the peripheral members thereof, and FIG. 9B is a bottom view of the stapleless binding mechanism 500 and the peripheral members thereof.

In the practice mode, the stapleless binding mechanism 500 includes a punching member 515 that provided in the base portion 503 and forms the tongue portion 522 in the sheet S constituting the sheet stack B. The punching member 515 has a blade portion 515c on a side thereof facing the base stage 501. It should be noted that, in the blade portion 515c, no blade is formed on a side facing the blade 504, and thereby the tongue portion 522 (refer to FIG. 5D) is not separated from the sheet S via the one end part 522a (refer to FIG. 5D).

The punching member 515 also includes a pushing mechanism 515d that is provided inside the punching member 515 to push the tongue portion 522 toward the eyelet 504a of the blade 504. The pushing mechanism 515 has a rotational axis 515r provided to one end thereof. The pushing mechanism 515 is rotatable around the rotational axis 515r.

Further, the stapleless binding mechanism 500 includes a pressing portion 516 that is provided inside the punching member to press the pushing mechanism 515d.

Moreover, the stapleless binding mechanism 500 includes a pressing member 517 on a side of the punching member 515 facing the blade 504. The pressing member 517 has a tip portion 517a the thickness of which is reduced as approaching the sheet stack B.

Further, in the practice mode, a first base portion cam 701 that moves the base portion 503 by rotating upon receiving a drive from the stapleless binding motor M1 is provided. Also, a second base portion cam 703 that moves the pressing portion 516 toward the pushing mechanism 515d by rotating upon receiving a drive from the stapleless binding motor M1 is provided. In the specific example shown in the figures, the first base portion cam 701 and the second base portion cam 703 are provided to a common shaft 705, and the common shaft 705 rotates upon receiving a drive from the stapleless binding motor M1. It should be noted that, as shown the figure, the second base portion cam 703 has an amount of pushing larger than that of the first base portion cam 701.

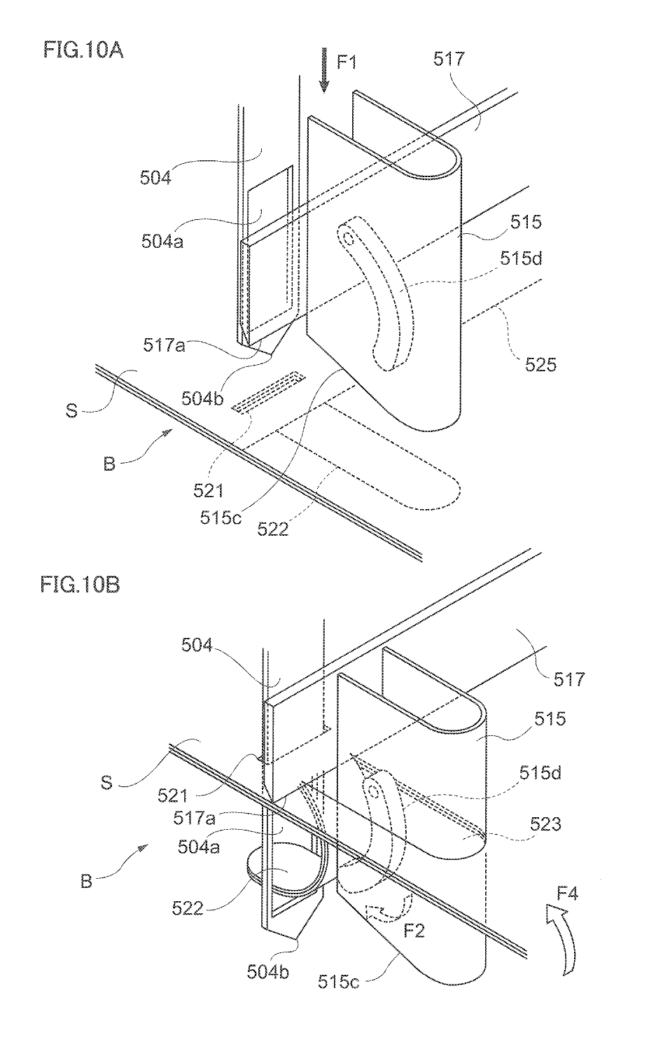

Next, with reference to FIGS. 9A-9B and 10A-10B, a binding operation in the exemplary embodiment will be described. Here, FIGS. 10A and 10B are illustrative diagrams showing a binding operation of the stapleless binding mechanism 500 in the other practice mode. It should be noted that the slit 521 and the tongue portion 522 indicated by broken lines in the sheet S of FIG. 10A are expected cutting lines.

As shown in FIG. 9A, the stapleless binding motor M1 drives to rotate the shaft 705 around which the first base portion cam 701 and the second base portion cam 703 are provided. This causes the base portion 503 receiving the drive from the first base portion cam 701 to approach the base stage 501 (direction F1 in the figure). Then the tip portion 504b of the blade 504 and the blade portion 515c of the punching member 515 penetrate the sheet stack B. Accordingly, as shown in FIG. 10A, the slit 521 and the tongue portion 522, in which the sheet S is punched with the one end part 522a being left, are formed in each sheet S constituting the sheet stack B.

After the tip portion 504b of the blade 504 and the blade portion 515c of the punching member 515 penetrate the sheet stack B, the second base portion cam 703 further rotates to move the pressing portion 516 toward the pushing mechanism 515d (direction F1 in FIG. 10A). Consequently, the pushing mechanism 515d is rotated around the rotational axis 515r provided at one end of the pushing mechanism 515d, and the other end of the pushing mechanism 515d pushes the punched tongue portion 522 toward the eyelet 504a of the blade 504 (direction F2 in FIGS. 9A and 10B). The stapleless binding motor M1 is stopped in this state.

Here, as the base portion 503 approaches the base stage 501 (direction F1 in FIG. 10A), the tip portion 517a of the pressing member 517 is pressed against the sheet stack B (refer to FIG. 10B). Then, the base stage motor M2 (refer to FIG. 9A) rotates the base stage cam 75 (refer to FIG. 9A), and thereby the movable base stage 501b is rotated (refer to F4 in FIG. 10B). Accordingly, the sheet stack B is folded with the tip portion 517a of the pressing member 517 being a fulcrum point. Moreover, as the base portion cam 75 (refer to FIG. 9A) further rotates, the movable base stage 501b is rotated in the opposite direction to return the sheet stack B from the folded state to a flat state. It should be noted that the pressing member 517 is in the state of holding the sheet stack B.

Next, the stapleless binding motor M1 drives again while the pressing member 517 holds the sheet stack B. After the base portion 503 is passed through the bottom dead center by further rotation of the first base portion cam 701 and the second base portion cam 703, while receiving a force from the base portion spring 80, the base portion 503 moves in the direction away from the base stage 501, and the tongue portion 522 is inserted into the slit 521 (bending the tongue portion 522 and pushing thereof into the slit 521).

### <Other Practice Mode 2>

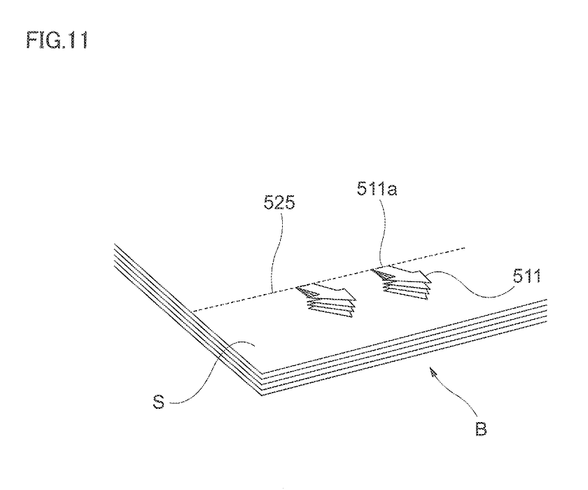

In the above-described practice mode, description has been given to the configuration in which the stapleless binding mechanism 50 (and the stapleless binding mechanism 500) binds the sheet stack B while forming the slit 521 and the tongue portion 522, however, the present invention is not limited thereto. Here, with reference to FIG. 11, description will be given to that the stapleless binding mechanism 50 may be of a different mode. FIG. 11 is an illustrative diagram showing the sheet stack B to which the binding process has been applied by another practice mode.

As shown in FIG. 11, an arrow-shaped cut (tongue portion) 511 is formed in the sheet S constituting the sheet stack B. The arrow-shaped cut 511 is punched so that an end portion 511a on a stick side (opposite to a head side) thereof is left to be not separated from the sheet S. The sheet stack B is bound by raising the arrow-shaped cut 511 and engaging the raised arrow-shaped cut 511 in a punched hole thereof.

Here, in the specific example shown in FIG. 11, the folding line 525 is formed at a position that does not pass through the raised arrow-shaped cut 511. This suppresses the possibility that the raised arrow-shaped cuts 511 are pushed into the sheet stack B by forming the folding line 525 and thereby the binding is released (sheets S become unbind). Specifically, in the specific example shown in FIG. 11, the folding line 525 is formed at a position that passes through the end portion 511a on the stick side (opposite to the head side) of the arrow-shaped cut 511. In the practice mode, the folding line 525 is arranged closer to the center portion of the sheet S than the arrow-shaped cut 511. This suppresses the possibility that the sheet S is turned over beyond the folding line 525 and that the binding by the arrow-shaped cut 511 is released (sheets S become unbind), when the sheet S is turned over.

### <Other Practice Mode 3>

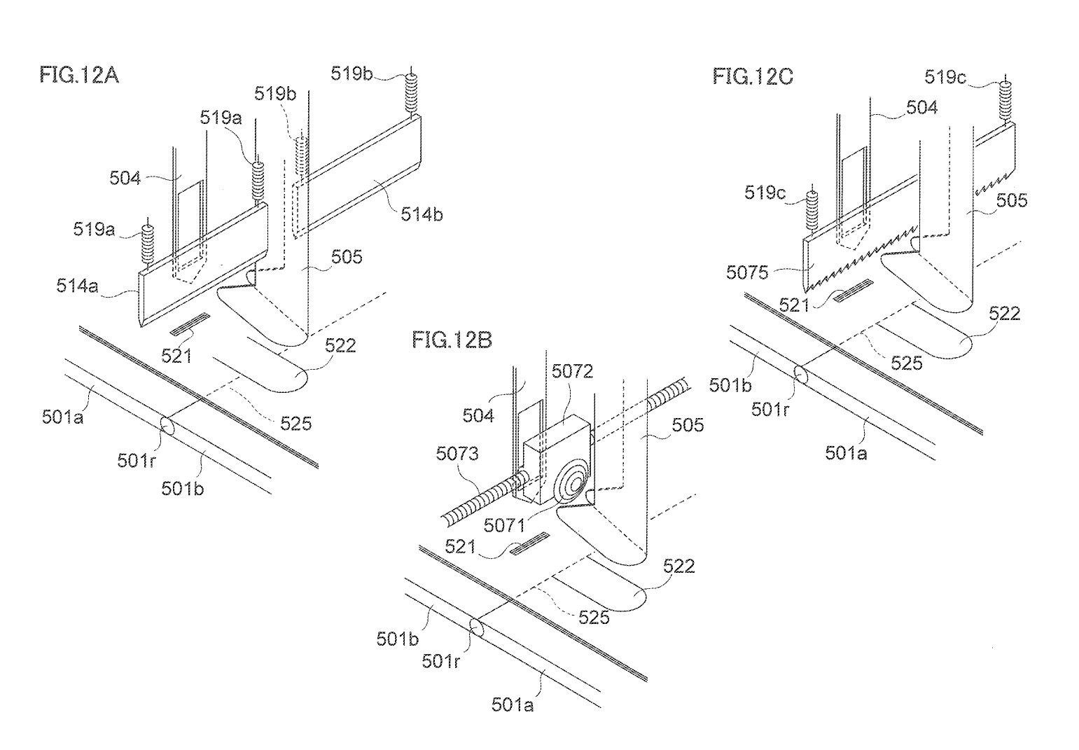

Here, with reference to FIGS. 8A-8D and 12A-12C, another practice mode will be described. It should be noted that FIGS. 12A-12C are schematic configuration diagrams showing another practice mode of the pressing member 507.

First, in the above-described practice modes, the pressing member 507 has been described as one member, but the present invention is not limited thereto. For example, as shown in FIG. 8B, in the case where the folding line 525 is formed at a position that passes between one end portion of the binding hole 523 facing the slit 521 and the other end portion of the binding hole 523 opposite to the one end portion facing the slit 521, the pressing member 507 may be configured by two members arranged with the punching member 505 interposed therebetween. For example, as shown in FIG. 12A, a first blade 514a and a second blade 514b are arranged with the punching member 505 interposed therebetween, and the first blade 514a and the second blade 514b are connected to the base portion 503 (refer to FIG. 2A) via a spring 519a and a 519b, respectively.

Further, in the above-described practice modes, the folding line 525 has been described to be formed by pressing the pressing member 507, however, the present invention is not limited thereto. For example, as shown in FIG. 12B, the configuration may include a roller blade 5071 that rotates while being pressed against the sheet stack B to form the folding line 525.

In this mode, the stapleless binding mechanism 50 has a holder 5072 that holds the roller blade 5072 rotatably, and a feed screw 5073 that is provided along the surface of the sheet stack B sandwiched by the base stage 501 and is equipped with the holder 5072.

By rotation of the feed screw 5073 upon receiving a drive from a not-shown driving source, the roller blade 5071 held by the holder 5072 moves on the sheet stack B while rotating to form the folding line 525.

Or, for example, as shown in FIG. 12C, the configuration may include a perforation cutter 5075 that forms not the folding line 525, but perforations.

In this mode, similar to the case of forming the folding line 525, the perforations cause the sheet S to be folded easier at a position thereof. The perforation cutter 5075 has pointed blade edges successively formed, and is connected to the base portion 503 (refer to FIG. 2A) via a spring 519c.

As the base portion 503 approaches the base stage 501 (refer to FIG. 2A), the blade of the perforation cutter 5075 is pressed against the sheet stack B to form the perforations.

### <Image Forming Apparatus 200>

In the above-described practice modes, description has been given to the configuration in which the sheet binding device 100 includes the stapleless binding mechanism 50 (and the stapleless binding device 500), however, the present invention is not limited thereto. For example, there may be a configuration in which an image forming apparatus provided with a mechanism that forms an image on a sheet S includes the stapleless binding mechanism 50, or, there may be a configuration in which an image reader provided with a mechanism that reads an image on a document includes the stapleless binding mechanism 50.

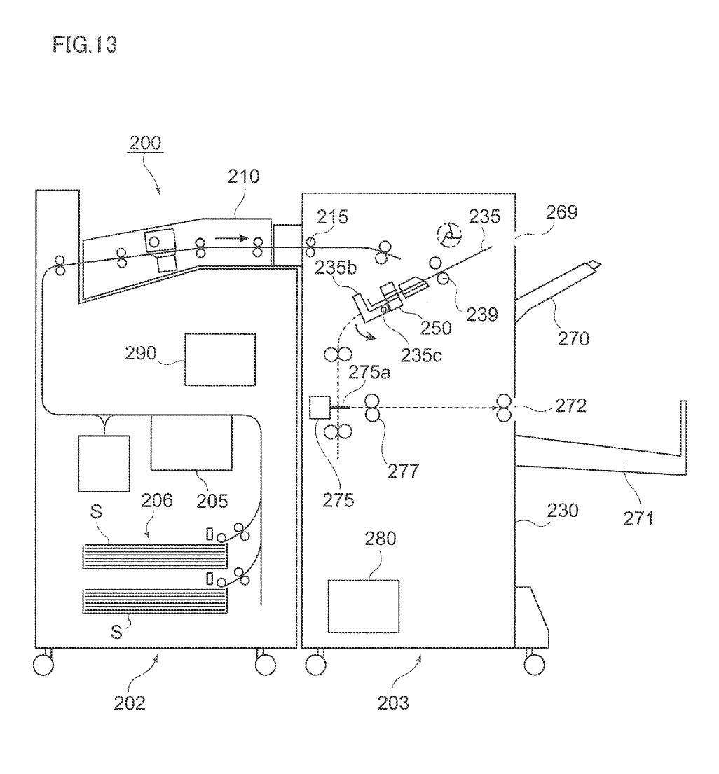

Here, with reference to FIG. 13, description will be given to an image forming apparatus 200 equipped with a stapleless binding mechanism 250. It should be noted that FIG. 13 is a schematic diagram showing the image forming apparatus 200 equipped with the stapleless binding mechanism 250.

The image forming apparatus shown in FIG. 13 includes, for example, an image forming unit 202 such as a printer or a copying machine that forms an image by an electrophotographic system, and a sheet processing unit 203 that applies a post process to a sheet S on which, for example, a toner image is formed by the image forming unit 202.

The image forming unit 202 includes a sheet supply unit 206 that supplies the sheet S on which an image is to be formed, and an image forming mechanism 205 that forms an image on the sheet S supplied from the sheet supply unit 206. Further, the image forming unit 202 includes a user interface 290 that receives information regarding the binding process from a user.

The sheet processing unit 203 includes a transport device 210 that further transports the sheet S outputted from the image forming unit 202 to the downstream side, and a post-processing device 230 including, for example, a compile stacking unit 235 that collects the sheets S to form a sheet stack, a stapleless binding mechanism 250 and the like. Further, in the specific example shown in the figure, the sheet processing unit 203 includes a controller 280 that controls the image forming apparatus 200 as a whole.

The post-processing device 230 of the sheet processing unit 203 includes a transport roll (sheet supply mechanism) 215 that further transports the sheet S transported from the transport unit 210 to the downstream side, and the compile stacking unit (sheet stack forming mechanism) 235 that collects plural sheets S and contains thereof. The compile stacking unit 235 includes an end guide 235b that aligns end portions on a leading end side in the traveling direction of the sheets S sliding down along the compile stacking unit 235, and a rotational axis 235c which becomes a center of rotation when the end guide 235b rotates as described later.

Further, the post-processing device 230 includes the stapleless binding mechanism 250 that binds an end portion of the sheet stack B stacked in the compile stacking unit 235. The stapleless binding mechanism 250 in the practice mode is configured similar to the stapleless binding mechanism 50 shown in FIGS. 2A and 2B.

The post-processing device 230 includes an eject roll 239 that transports the bound sheet stack B by rotating in a forward or backward direction. The eject roll 239 rotates in the forward direction to transport the sheet stack B in a direction further sliding down along the compile stacking unit 235 or rotates in the backward direction to transport the sheet stack B in a direction climbing up along the compile stacking unit 235.

The post-processing device 230 has a first opening portion 269 for letting the sheet stack B transported by rotation of the eject roll 239 in the backward direction exit to the outside of the post-processing device 230. The post-processing device 230 also includes a first stacking unit 270 for stacking the sheet stack B outputted from the first opening portion 269 so that a user can easily pick up the sheet stack B.

Moreover, the post-processing mechanism 230 includes a folding mechanism 275 that folds the sheet stack B transported by rotation of the eject roll 239 in the forward direction. The folding mechanism 275 includes a folding knife 275a that moves to project into the transport path on which the sheet stack B is transported. Further, the post-processing device 230 includes a folding roll 277 that pinches the sheet stack B on which folding by the folding knife 275a is started.

The post-processing device 230 has a second opening portion 272 for letting the sheet stack B folded by the folding mechanism 275 and the folding roll 277 exit to the outside of the post-processing device 230. The post-processing device 230 also includes a second stacking unit 271 for stacking the sheet stack B outputted from the second opening portion 272 so that a user can easily pick up the sheet stack B.

### <Operation of Image Forming Apparatus 200>

Next, operations of the image forming apparatus 200 will be described.

First, the toner image is formed on the first sheet S by the image forming mechanism 205 of the image forming apparatus 200. The first sheet S on which the toner image is formed is supplied one by one to the post-processing device 230. Then the first sheet S is received by the compile stacking unit 235 of the post-processing device 230. Each of the second and subsequent sheets S, following after the first sheet S, on which the toner image is formed by the image forming mechanism 205 is supplied to the post-processing device 230 in order. In this way, a preset number of sheets S are contained in the compile stacking unit 235, the end portion of each sheet S is aligned, and thereby the sheet stack B is formed.

Next, the end portion of the sheet stack B stacked on the compile stacking unit 235 is bound and the folding line 525 (refer to FIG. 5D) is formed by the stapleless binding mechanism 250. The sheet stack B on which the folding line 525 has been formed exits from the compile stacking unit 235 by rotation of the eject roll 239 in the backward direction. Then the sheet stack B passes through the first opening portion 269 and is outputted to the first stacking unit 270.

Here, in the practice mode, the following operation is available as an alternative to the formation of the folding line 525 in the sheet stack B by the stapleless binding mechanism 250. That is, the folding line 525 is not formed by the stapleless binding mechanism 250, but separately formed by the folding mechanism 275 and the folding roll 277, in the sheet stack B.

Specifically, the sheet stack B is formed by containing the sheets S with end portion of each sheet S being aligned. Then, the end portion of the sheet stack B stacked in the compile stacking unit 235 is bound by the stapleless binding mechanism 250. It should be noted that the folding line 525 is not formed by, for example, not driving the base stage motor M2 when the binding process is applied by the stapleless binding mechanism 250.

Next, while the end guide 235b is rotated around the rotational axis 235c in the direction away from the sheet stack B (refer to an arrow in FIG. 13), the eject roll 239 rotates in the forward direction to output the sheet stack B to which the binding process has been applied from the compile stacking unit 235. On the sheet stack B transported to the downstream, the folding line 525 is formed by the folding mechanism 275 and the folding roll 277. The sheet stack B, on which the folding line is formed, passes through the second opening portion 272 and is outputted to the second stacking unit 271.

As the case where the folding line 525 is formed on the sheet stack B by not the stapleless binding mechanism, but the folding mechanism 275 and the folding roll 277, there is a case of folding the center portion of the sheet S as shown in FIGS. 7A and 7B. In this case, the binding mechanism 250 is downsized and simplified because, in forming the folding line 525 by the folding mechanism 275 and the folding roll 277, a required space is suppressed due to the movement of the movable base stage 501b that rotates around the rotational axis 501r.

Further, as another alternative example, the sheet S may be stacked on the compile stacking unit 235 after the folding line 525 is formed on each one of the sheets S, without forming the folding line 525 by the stapleless binding mechanism 250. Specifically, a folding line forming mechanism (not shown in the figure) may be provided on the sheet transport path upstream of the compile stacking unit 235. As the folding line forming mechanism, for example, a roller blade (not shown in the figure) that forms the folding line 525 on the sheet S by rotating while being pressed against the transported sheet S may be provided. This simplifies the configuration of the stapleless binding mechanism 250.

Moreover, in the case where the folding line 525 is formed on each one of the sheets S, there is a mode in which the folding line 525 is formed on all of the sheets S constituting the sheet stack B, or a mode in which the folding line 525 is formed on only a part of the sheets S constituting the sheet stack B. For example, as the mode in which the folding line 525 is formed on only a part of the sheets S constituting the sheet stack B, the folding line 525 is formed only on the sheets S on the top surface side of the sheet stack B. It should be noted that the folding line 525 formed on each one of the sheets S may be the perforations (refer to FIG. 12C).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet binding device comprising:
a binding mechanism that cuts a part of a sheet stack into a predetermined shape to form a tongue portion in the sheet stack, the tongue portion having a part where one end part of the tongue portion is not separated from the sheet stack, and binds the sheet stack by bending the tongue portion to make the sheets of the sheet stack engage each other; and
a folding mechanism that makes a fold in the sheet stack in conjunction with the binding operation of the binding mechanism.

2. The sheet binding device according to claim 1, wherein the binding mechanism binds the sheet stack by forming a cut in the sheet stack and bending the tongue portion to insert another end part of the tongue portion into the cut.

3. The sheet binding device according to claim 1, wherein the folding mechanism makes the fold in the sheet stack after the binding mechanism bends the tongue portion.

4. The sheet binding device according to claim 2, wherein the folding mechanism makes the fold in the sheet stack after the binding mechanism bends the tongue portion.

5. The sheet binding device according to claim 1, further comprising a holding member that holds the sheet stack, wherein the folding mechanism makes the fold in the sheet stack after the sheet stack is bound by the binding mechanism while being held by the holding member and the holding member maintains a state of the bound sheet stack being held.

6. The sheet binding device according to claim 2, further comprising a holding member that holds the sheet stack, wherein the folding mechanism makes the fold in the sheet stack after the sheet stack is bound by the binding mechanism while being held by the holding member and the holding member maintains a state of the bound sheet stack being held.

7. The sheet binding device according to claim 3, further comprising a holding member that holds the sheet stack, wherein the folding mechanism makes the fold in the sheet stack after the sheet stack is bound by the binding mechanism while being held by the holding member and the holding member maintains a state of the bound sheet stack being held.

8. The sheet binding device according to claim 4, further comprising a holding member that holds the sheet stack, wherein the folding mechanism makes the fold in the sheet stack after the sheet stack is bound by the binding mechanism while being held by the holding member and the holding member maintains a state of the bound sheet stack being held.

9. A post-processing device comprising:
a sheet supply mechanism that supplies a sheet;
a sheet stack forming mechanism that forms a sheet stack by bundling a plurality of sheets supplied by the sheet supply mechanism;
a binding mechanism that cuts a part of the sheet stack into a predetermined shape to form a tongue portion in the sheet stack, the tongue portion having a part where one end part of the tongue portion is not separated from the sheet stack, and binds the sheet stack by bending the tongue portion to make the sheets of the sheet stack engage each other; and
a folding mechanism that makes a fold in the sheet stack in conjunction with the binding operation of the binding mechanism.

10. An image forming apparatus comprising:
an image forming mechanism that forms an image on a sheet;
a sheet stack forming mechanism that forms a sheet stack by bundling a plurality of sheets, on each of which the image is formed by the image forming mechanism;
a binding mechanism that cuts a part of the sheet stack into a predetermined shape to form a tongue portion in the sheet stack, the tongue portion having a part where one end part of the tongue portion is not separated from the sheet stack, and binds the sheet stack by bending the tongue portion to make the sheets of the sheet stack engage each other; and
a folding mechanism that makes a fold in the sheet stack in conjunction with the binding operation of the binding mechanism.
